(19) United States
(12) Patent Application Publication
(10) Pub. No.: US 2018/0231051 A1
(43) Pub. Date: Aug. 16, 2018

(54) BALL JOINT FOR A VEHICLE WITH A TILT ANGLE MEASURING DEVICE

(71) Applicant: ZF Friedrichshafen AG, Friedrichshafen (DE)

(72) Inventors: Michael KLANK, Osnabrück (DE); Klaus HASKAMP, Dinklage (DE)

(21) Appl. No.: 15/769,774

(22) PCT Filed: Sep. 28, 2016
(86) PCT No.: PCT/EP2016/073106

§ 371 Date: Apr. 20, 2018

(30) Foreign Application Priority Data
Oct. 23, 2015 (DE) 10 2015 220 757.9

(51) Int. Cl. F16C 11/06; F16C 41/00

(52) U.S. Cl. CPC F16C 11/0604; F16C 41/007; F16C 11/0619

(57) ABSTRACT

A ball joint (1) for a vehicle, with a housing (2) and a ball stud (3) that extends in an axial direction (A) and includes a joint ball (4) which, with its joint ball (4), is fitted into and can pivot in the housing (2) and which extends outward through an opening (8) of the housing (2). At least one sensor (6) serves to detect a tilt angle (a) between the ball stud (3) and the housing (2). The joint ball (4) has a flattened area (5) and the at least one sensor (6) is a distance sensor arranged on a wall (7) of the housing (2), opposite the flattened area (5) of the joint ball (4), for detecting a distance (d) from the flattened area (5) and, from the detected distance (d) from the flattened area (5), deriving the tilt angle (a).

This application is a National Stage completion of PCT/EP2016/073106 filed Sep. 28, 2016, which claims priority German patent application serial no. 10 2015 220 757.9 filed Oct. 23, 2015.

### FIELD OF THE INVENTION

The invention relates to a ball joint for a vehicle, having a housing and a ball stud that extends in an axial direction and comprises a joint ball, which is fitted with its joint ball into and able to pivot in the housing and which extends outward through an opening of the housing, and with at least one sensor that serves to determine a tilt angle between the ball stud and the housing.

### BACKGROUND OF THE INVENTION

Ball joints of this type are known from the prior art. For example the German published patent application DE10350640B4 describes a ball joint for a motor vehicle, with a housing having a cavity and a ball stud with a stud and a joint ball, which with its joint ball is fitted into and can rotate and pivot in the cavity of the housing. The stud extends through an opening provided in the housing and a sealing bellows is provided, which is arranged between the housing and the stud. In addition a multi-component measuring arrangement is disclosed, which comprises at least one signal emitter and at least one sensor, such that the measuring arrangement is located between the housing, in the area of the end of the joint ball on the stud side, and the end of the sealing bellows on the stud side.

Furthermore, in the German published patent application DE102010052885A1 a load carrier or bike carrier for a motor vehicle is disclosed, wherein the load carrier comprises a fixing device with clamping components, such that by the action of a powered holder the clamping components hold a trailer ball of a trailer coupling secure in a housing for receiving the trailer ball, in such manner that the housing can pivot relative to the trailer ball. The housing also comprises two sensors which determine the distance to the trailer ball. When the two sensors determine the same distance to the trailer ball, the powered holder is activated in order to secure a given orientation of the housing or load carrier relative to the trailer ball. For this, the sensors are arranged on the upper wall of the housing and they measure a distance to a flattened area of the trailer ball.

The German published patent application DE 102010030246 A1 discloses a ball joint for a vehicle, which comprises a housing and a ball stud. An angle-measuring device with field-generating components is described, by means of which movement of the ball stud relative to the housing can be detected, the field-generating components being arranged opposite a joint ball of the ball stud. The joint ball has a surface region which deviates from the spherical surface shape of the joint ball. This surface region interacts with the magnetic field of the field-generating components.

A disadvantage of the systems described in the prior art, among others, is that greater cost and effort are entailed for machining the joint ball during its production. Moreover, conventional measurement devices for ball joints often use a magnetically based sensor system, which is sensitive to interference from external magnetic fields.

### SUMMARY OF THE INVENTION

The purpose of the present invention is to propose a robust ball joint which can be produced inexpensively, and which enables the tilt angle between the housing and the ball stud to be determined in a simple manner.

That objective is achieved by a ball joint according to the independent claims. Advantageous design features of the invention are the object of the subordinate claims.

Thus the objective is achieved with a ball joint for a vehicle, having a housing and a ball stud that extends in an axial direction and comprises a joint ball, which with its joint ball is fitted into and can pivot in the housing and which extends outward through an opening of the housing, and at least one sensor which detects a tilt angle between the ball stud and the housing, wherein the joint ball has a flattened area and the at least one sensor is a distance sensor arranged on a wall of the housing opposite the flattened area of the joint ball in order to detect a distance from the flattened area and from that to derive the tilt angle. The sensor can be fitted on the inside surface of the housing wall by any common fixing means, for example by adhesive bonding and/or screwing. However, the at least one sensor can also be set into the housing wall. For this an opening, blind hole or through-going bore can be provided. It is also possible for the wall of the housing to be prefabricated and the sensor integrated as part of the prefabricated wall. Thus, the sensor can be positioned in the housing wall and subsequently cast or overmolded into place. In the context of the present invention the term flattened area is understood to mean a part of the surface of the joint ball which in an entirely general way has a smaller curvature (in the sense of being flatter) compared with the spherical curvature. In a preferred design, the curvature of the flattened area can be zero so that it forms a flat plane. In contrast to the machined surfaces described in the prior art, the flattened area of the joint ball can be produced very easily. Furthermore, the use of a distance sensor avoids sensitivity to magnetic interferences.

In an embodiment of the ball joint the flattened area extends substantially perpendicularly to the axial direction of the ball stud. The distance sensor always detects the distance between the sensor and this flattened area. When the ball stud moves in the housing, the flattened area moves one way or the other. If the tilt angle between the ball stud and the housing changes, the distance between the sensor and the flattened area correspondingly changes as well. If the relationship between the distance and the tilt angle is known, the tilt angle of the ball joint can be determined by way of that relationship with reference to the distance.

As already mentioned earlier, in a preferred embodiment the flattened area forms a flat plane. Accordingly the correlation or relationship between the distance and the tilt angle can be described by a simple mathematical formula. It is then also possible to use a simple algorithm to determine the tilt angle with reference to that distance. Thus, the range of error of the tilt angle determination can also be reduced.

In an embodiment the flattened area is a substantially circular surface. This simplifies the production of the ball joint. In contrast, in the prior art, for example in the document DE102010030246 A1 the surface of the joint ball is machined in a complex production process. Or in DE10110738, for example, a blind hole is drilled into the joint ball in order to accommodate a magnetic field producer. Thus, the region of the circular surface of the ball joint has significant advantages in relation to production costs.

The at least one sensor is a sensor used to determine the distance based on an inductive, capacitative and/or optical measurement method. A ball joint for a vehicle can sometimes be within the range of influence of an external magnetic field. A sensor that functions on the basis of an inductive, capacitative and/or optical measurement process has the advantage that it is not influenced by such magnetic fields. Accordingly, a ball joint of that type is very resistant to magnetic interference.

In one embodiment, the at least one sensor is positioned on the wall of the housing symmetrically relative to a specified pivoting axis of the ball joint, so that when the tilt angle between the housing and the ball stud is zero degrees, the sensor detects the distance relative to a defined diameter of the flattened area parallel to the specified pivoting axis. In other words: the sensor is positioned on the housing wall centrally relative to the pivoting axis. Thus, the sensor measures the distance to the middle of the flattened area when the tilt angle is zero degrees. When the ball stud tilts in a pivoting direction, the flattened area tilts relative to the sensor. Thus, the distance between the sensor and the flattened area decreases. Accordingly, the tilt angle can be determined unambiguously from the distance detected. However, the pivoting direction cannot be determined, i.e. the ball joint cannot distinguish between a positive tilt angle and a negative tilt angle. The ball stud can move within a specified range of movement relative to the housing. For example, the ball stud can pivot by 40 degrees relative to the housing. In the context of the invention, a tilt angle of zero degrees denotes the situation in which the ball stud is in the middle of its range of movement. Thus for example, the ball stud can pivot between +20 degrees and −20 degrees. In one embodiment, at least one sensor is positioned on the wall of the housing in such manner that when the tilt angle between the housing and the ball stud is zero degrees, the sensor is opposite the center point of the flattened area and therefore detects the distance relative to the center point. Thus, regardless of the pivoting direction, the sensor or the ball joint can detect an absolute value, namely the distance or the tilt angle. In this case the sensor is always positioned opposite a diameter of the flattened area.

In one embodiment the ball joint comprises an evaluation unit which serves to determine the tilt angle with reference to a distance value, the distance value corresponding to the distance detected.

In an embodiment of the ball joint, the at least one sensor is positioned on the wall of the housing asymmetrically relative to a specified pivoting axis of the ball joint, so that when the tilt angle between the housing and the ball stud is zero degrees the sensor detects the distance relative to a defined chord of the flattened area parallel to the specified pivoting axis, such that this chord does not correspond to any diameter of the flattened area. In other words, the sensor is positioned eccentrically. Thus, when the ball stud pivots a functional relationship exists between the distance and the tilt angle, which although it is not linear, enables differentiation between positive and negative tilt angles over a certain range of movement of the ball stud.

In a further development, a first and a second sensor are arranged on the wall of the housing asymmetrically relative to a specified pivoting axis of the ball joint, so that when the tilt angle between the housing and the ball stud is zero degrees the first sensor detects the distance relative to a first chord of the flattened area and the second sensor detects the distance relative to a second chord of the flattened area, such that the first chord and the second chord extend parallel to one another and parallel to a diameter of the flattened area and the first chord extends in a first partial zone of the flattened area and the second chord extends in a second partial zone of the flattened area, and the first and second partial zones are separated from one another by the diameter of the flattened area. When two sensors are used, one being to the right and the other to the left of the center, a clear and linear relationship can be determined between the tilt angle and the distance. Thus the full range of movement of the ball stud can be covered by the sensors, so that an unambiguous association of the tilt angle with the distance can be made. Furthermore, if the sensors are positioned the same distance away from the diameter, the characteristic lines that express the relationship between the distance and the tilt angle can be subtracted from one another. As a result a characteristic line is obtained which represents a linear relationship between the distance and the tilt angle.

In one embodiment, the ball joint comprises an evaluation unit, which serves to determine the tilt angle with reference to a first distance value and a second distance value, the distance values corresponding to the first distance and the second distance detected, and such that the evaluation unit is designed to subtract the first distance value from the second distance value.

In a design version at least two sensors are arranged on the wall of the housing, these at least two sensors serving to determine the tilt angle between the ball stud and the housing in relation to two pivoting directions different from one another.

The objective of the invention can, further, be achieved by a device comprising an evaluation unit and a ball joint, the device comprising a communication path that connects the evaluation unit and the ball joint, and wherein the evaluation unit serves to determine the tilt angle with reference to a distance value that corresponds to the distance detected.

Alternatively, the object can be achieved by a device comprising an evaluation unit and a ball joint, the device comprising a communication path that connects the evaluation unit and the ball joint, and wherein the evaluation unit serves to determine the tilt angle with reference to a first distance value and a second distance value, such that the distance values correspond to the first and second distances detected, and such that the evaluation unit is designed to subtract the first distance value from the second distance value.

### BRIEF DESCRIPTION OF THE DRAWINGS

Below, the invention is explained in more detail with reference to the following figures, which show:

FIGS. 1 a,1 b: A schematic representation of a first embodiment of a ball joint, and a graphical representation of the relationship between distance and tilt angle in the embodiment shown in FIG. 1a;

FIGS. 2a, 2b: A schematic representation of a second embodiment of a ball joint, and a graphical representation of the relationship between distance and tilt angle in the embodiment shown in FIG. 2a;

FIGS. 3a, 3b: A schematic representation of a third embodiment of a ball joint, and a graphical representation of the relationship between distance and tilt angle in the embodiment shown in FIG. 3a.

### DETAILED DESCRIPTION OF THE PREFERRED EMBODIMENTS

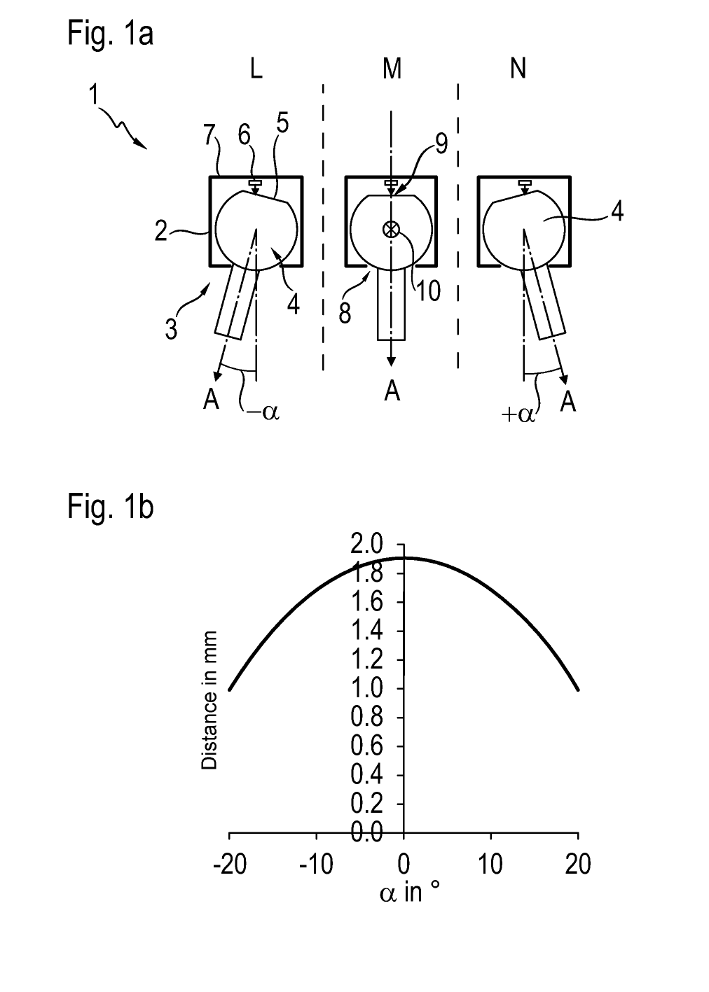

FIG. 1a shows a ball joint 1 with a housing 2 and a ball stud 3. The ball stud 3 has a joint ball 4 and the joint ball 4 has a flattened area 5. Opposite this flattened area 5 is arranged a sensor 6 on the housing wall 7. The sensor 6 is a distance sensor. The ball stud 3 extends out of the housing 2 in an axial direction A through an opening 8. The ball joint 1 is shown in three different positions L, M and N. In the first position L there is a negative tilt angle −α between the ball stud 3 and the housing 2. In the second position M the tilt angle α between the ball stud 3 and the housing 2 is 0 degrees, and in the third position N there is a positive tilt angle +α between the ball stud 3 and the housing 2. The axial direction A of the ball stud 3 is in each case indicated by a straight line A. When the tilt angle α between the ball stud 3 and the housing 2 is 0 degrees, as shown in the second position M in FIG. 1a, it is easy to see that the sensor 6 is positioned directly opposite a center point 9 of the flattened area 5.

FIG. 1b shows in graphical form the relationship between the distance d and the tilt angle α. When the tilt angle α is 0 degrees, the distance d between the sensor 6 and the flattened area 5 is plainly a maximum. When the ball stud 3 pivots to one side or the other, the distance d between the flattened are 5 and the sensor 6 decreases. However, as can be seen in FIG. 1b it is not possible to distinguish between positive and negative angles. In other words, with a particular measured distance d the ball joint 1 cannot carry out any specific assignment but the ball joint 1 can only deliver an absolute value |α| of the tilt angle.

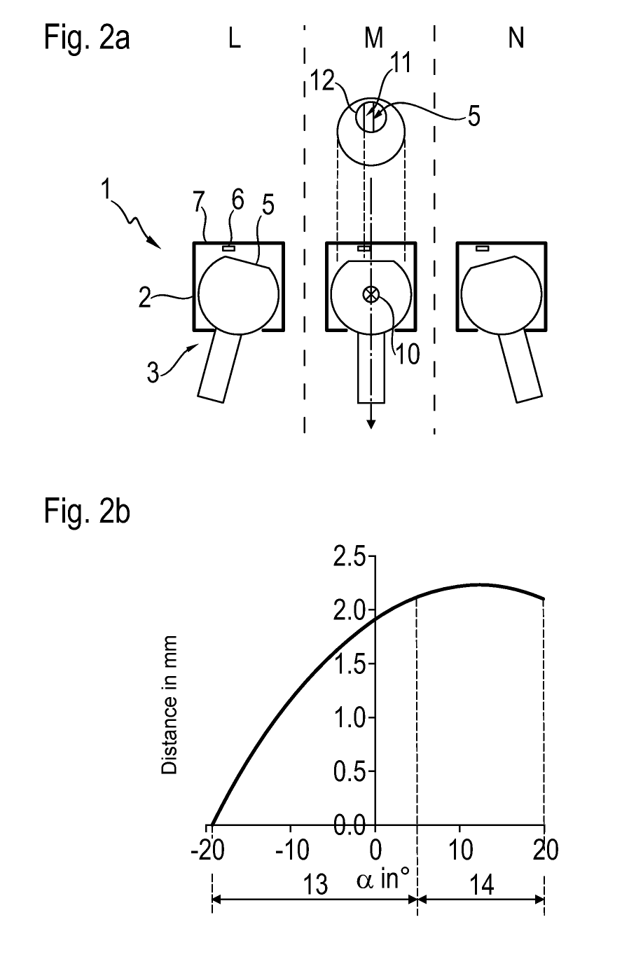

FIG. 2a shows a schematic representation of a second embodiment of a ball joint 1. Here too, as in FIG. 1a, three positions L, M, N of the ball stud 3 relative to the housing 2 are shown. The essential difference from the embodiment shown in FIG. 1a is that the sensor 6 is arranged asymmetrically on the wall 7 of the housing 2. This asymmetry is relative to a diameter 11 of the flattened area 5, which can be defined with reference to the pivoting axis 10. The diameter 11, which is parallel to the pivoting axis 10, is taken as a line of reference which divides the flattened area 5 into two halves. In FIG. 2a the sensor 6, which is positioned asymmetrically on the housing wall 7, detects the distance d relative to a chord 12 of the flattened area 5 when the tilt angle α between the ball stud 3 and the housing 2 is zero degrees. Thus, the sensor detects the distance d between the housing wall 7 and a point in a given half of the flattened area 5.

FIG. 2b shows a graphical representation of the functional relationship between the distance d and the tilt angle α of the embodiment shown in FIG. 2a. In this case it should be recognized that over a specified range of movement 13 of the ball stud 3 a clear association between the distance d and the tilt angle α is possible. However, there is another range of movement 14 within which this clear association is not apparent. Moreover, the functional relationship is not linear.

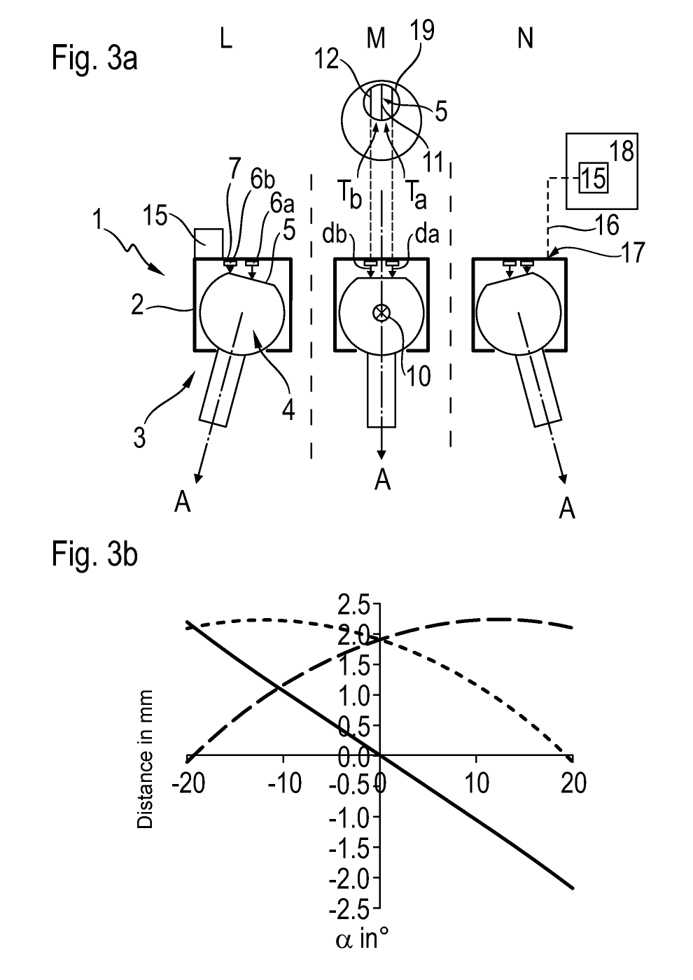

FIG. 3a shows a schematic representation of a third embodiment of a ball joint 1. In FIG. 3a the ball joint 1 is shown with a housing 2, a ball stud 3, the joint ball 4 and a sensor 6. As in FIGS. 1a and 2a the joint ball 4 has a flattened area 5, and at least one sensor 6 is arranged on a wall 7 of the housing 2 opposite the flattened area 5. In FIG. 3a two sensors 6a and 6b are shown. As in FIG. 2a these two sensors 6a, 6b are arranged asymmetrically. The asymmetry is in relation to the longitudinal axis A of the ball stud 3 when the ball stud 3 is tilted by 0 degrees relative to the housing 2. However, the asymmetry can also be in relation to a diameter 11 of the flattened area 5, the diameter 11 extending parallel to the pivoting axis 10 of the ball joint 1.

As shown in FIG. 3b, there is a functional relationship between the distance d and the tilt angle α for each of the sensors 6a, 6b. By virtue of that functional relationship a clear association between distance d and tilt angle α is possible over a specified free range of movement (between −α and +α) of the ball stud 3. With the use of two sensors 6a, 6b as shown in FIG. 3a, it is possible to cover the full range of movement (−α to +α) of the ball stud 3 with clear functional relationships. It is also possible, as shown in FIG. 3b, to derive a linear functional relationship from the individual functional relationships of the two sensors 6a, 6b. In this case, that can be done, for example, by subtracting the distance dₐ detected by a first sensor 6a from the distance d_{b} detected by a second sensor 6b. This gives a linear functional relationship between the distance measurement values dₐ, d_{b} and the tilt angle α. In general, the distance sensors 6a, 6b can use various measurement principles. In particular, inductive measurement methods, capacitative measurement methods and/or optical measurement methods can be used. The sensors 6a, 6b detect the distance d and transmit a measurement value to an evaluation unit 15. The evaluation unit 15 accepts this distance value or measurement value as an input, processes the measurement value in accordance with the specifications of an algorithm and emits a value that corresponds to the tilt angle α between the ball stud 3 and the housing 2. The evaluation unit 15 can either be arranged on the ball joint 1 itself, as shown in the first position L in FIG. 3a, or a communication path 16 to an external evaluation unit 15 can be provided. For example a connection 17 to a CAN bus can be provided and the evaluation unit 15 can be arranged on a main control system 18 of the vehicle (see the third position N in FIG. 3a).

### INDEXES

1 Ball joint
2 Housing
3 Ball stud
4 Joint ball
5 Flattened area
6 Sensor
7 Wall of the housing
8 Opening in the housing
9 Center point of the flattened area
10 Pivoting axis
11 Diameter
12 (Second) chord
13 First range of movement
14 Second range of movement
15 Evaluation unit
16 Communication path
17 Connection
18 Central control system of a vehicle
19 First chord
α Tilt angle
d Distance or gap
A Axial direction of the ball stud

1-14. (canceled)

15. A ball joint (1) for a vehicle comprising:
a housing (2),
a ball stud (3) that extends in an axial direction (A) and comprises a joint ball (4),
the ball stud and the joint ball (4) being fitted into and pivotable in the housing (2), and
the ball stud extends outward through an opening (8) of the housing (2), and at least one sensor (6) for detecting a tilt angle (a) between the ball stud (3) and the housing (2),
wherein the joint ball (4) has a flattened area (5), and
the at least one sensor (6) is a distance sensor arranged on a wall (7) of the housing (2), opposite the flattened area (5) of the joint ball (4), for detecting a distance (d) from the flattened area (5), and for deriving the tilt angle (α) from the detected distance from the flattened area.

16. The ball joint (1) according to claim 15, wherein the flattened area (5) extends essentially perpendicularly to the axial direction (A) of the ball stud (3).

17. The ball joint (1) according to claim 15, wherein the flattened area (5) is a flat plane.

18. The ball joint (1) according to claim 15, wherein the flattened area (5) is substantially a circular surface.

19. The ball joint (1) according to claim 15, wherein the at least one sensor (6) determines the distance (d) on a basis of at least one of an inductive, a capacitative, and an optical measurement method.

20. The ball joint (1) according to claim 15, wherein the at least one sensor (6) is arranged on the wall (7) of the housing (2) symmetrically in relation to a specified pivoting axis (10) of the ball joint (1) so that when the tilt angle (α), between the housing (2) and the ball stud (3), is zero degrees, the at least one sensor (6) determines the distance (d) relative to a defined diameter (11) of the flattened area (5) which is parallel to the specified pivoting axis (10).

21. The ball joint (1) according to claim 15, wherein the at least one sensor (6) is arranged on the wall (7) of the housing (2) such that when the tilt angle (α), between the housing (2) and the ball stud (3), is zero degrees, the at least one sensor (6) is opposite a center point (9) of the flattened area (5) and so determines the distance (d) from the center point (9).

22. The ball joint (1) according to claim 15, wherein the ball joint (1) comprises an evaluation unit (15) which serves to determine the tilt angle (α) based on a distance value that corresponds to the detected distance (d).

23. The ball joint (1) according to claim 15, wherein the at least one sensor (6) is arranged on the wall (7) of the housing (2) asymmetrically in relation to a specified pivoting axis (10) of the ball joint (1) such that when the tilt angle (α), between the housing (2) and the ball stud (3), is zero degrees, the at least one sensor (6) detects the distance (d) relative to a defined chord (12) of the flattened area (5) parallel to the specified pivoting axis (10), such that the chord (12) does not correspond to any diameter (11) of the flattened area (5).

24. The ball joint (1) according to claim 15, wherein a first sensor (6a) and a second sensor (6b) are arranged asymmetrically in relation to a specified pivoting axis (10) of the ball joint (1) so that when the tilt angle (α), between the housing (2) and the ball stud (3), is zero degrees, the first sensor (6a) detects a first distance (dₐ) from a first chord (19) of the flattened area (5) and the second sensor (6b) detects a second distance (d_{b}) from a second chord (12) of the flattened area (5), the first chord (19) and the second chord (12) extend parallel to one another and parallel to a diameter (11) of the flattened area (5), the first chord (19) extends in a first partial zone (Ta) of the flattened area (5) and the second chord (12) extends in a second partial zone (Tb) of the flattened area (5), and the first partial zone (Ta) and the second partial zone (Tb) are separated from one another by the diameter (11) of the flattened area (5).

25. The ball joint (1) according to claim 23, wherein the ball joint (1) comprises an evaluation unit (15) which serves to determine the tilt angle (α) with reference to first and second distance values (dₐ, d_{b}) that correspond to the detected first and the second distances (dₐ, d_{b}), and the evaluation unit (15) subtracts the first distance value (dₐ) from the second distance value (d_{b}).

26. The ball joint (1) according to claim 15, wherein at least two sensors (6) are arranged on the wall (7) of the housing (2), the at least two sensors (6) serve to determine the tilt angle (α) between the ball stud (3) and the housing (2) in relation to two pivoting directions (10a, 10b) which are different from one another.

27. A device comprising:
an evaluation unit (15) and a ball joint (1) for a vehicle,
the ball joint having a housing (2) and a ball stud (3) extending in an axial direction (A) and comprising a joint ball (4), the ball stud and the joint ball (4) being fitted into and pivotable in the housing (2),
the ball stud extending outward through an opening (8) of the housing (2), and
at least one sensor (6) for detecting a tilt angle (α) between the ball stud (3) and the housing (2),
wherein the joint ball (4) has a flattened area (5),
the at least one sensor (6) is a distance sensor arranged on a wall (7) of the housing (2) opposite the flattened area (5) of the joint ball (4) for detecting a distance (d) from the flattened area (5) and, from the distance from the flattened area, deriving the tilt angle (α),
the device comprises a communication path (16) that connects the evaluation unit (15) and the ball joint (1), and the evaluation unit (15) serves to determine the tilt angle (α) with reference to a distance value (d) that corresponds to the detected distance (d).

28. The device comprising an evaluation unit (15) and a ball joint (1) according to claim 27, wherein the device comprises the communication path (16) that connects the evaluation unit (15) and the ball joint (1), and the evaluation unit (15) serves to determine the tilt angle (α) with reference to first and second distance values (dₐ, d_{b}) that correspond to detected first and second distances (dₐ, d_{b}), and the evaluation unit (15) is designed to subtract the first distance value (dₐ) from the second distance value (d_{b}).

29. A ball joint for a vehicle, the ball joint comprising:
a housing and a ball stud, the ball stud having a joint ball that is pivotably mounted within the housing, the ball stud extending in an axial direction through an opening in the housing, and the joint ball having a flattened area;
at least one sensor being a distance sensor for detecting distance, the at least one sensor being mounted on a housing wall within the housing and opposite from the flattened area of the joint ball, and the at least one sensor detecting a distance between the at least one sensor and the flattened area of the joint ball; and
an evaluation unit being connected to the at least one sensor, the evaluation unit determining a tilt angle of the ball stud, relative to the housing, based on the detected distance between the at least one sensor and the flattened area of the joint ball.

30. The ball joint according to claim 29, wherein the at least one sensor being mounted on the housing wall within the housing such that a change in the distance between the at least one sensor and the flattened area of the joint ball corresponds to a change of the tilt angle of the ball stud, relative to the housing, as the ball stud pivots relative to the housing.
